(19) United States
(12) Patent Application Publication
(10) Pub. No.: US 2014/0281124 A1
(43) Pub. Date: Sep. 18, 2014

(54) SYSTEM AND METHOD FOR CACHING A STORAGE MEDIUM

(71) Applicant: BRYAN E. VEAL, Beaverton, OR (US)

(72) Inventor: BRYAN E. VEAL, Beaverton, OR (US)

(21) Appl. No.: 13/827,071

(22) Filed: Mar. 14, 2013

(51) Int. Cl. G06F 12/02; G06F 12/12

(52) U.S. Cl. CPC G06F 12/0246; G06F 12/128
USPC 711/103; 711/133

(57) ABSTRACT

A standalone storage cache is responsive to a host independent of drivers or caching logic on the host. The standalone storage cache (standalone cache) interfaces between the host and corresponding storage device, and appears to each as the same I/O interface. I/O requests are sent by the host, and received/acknowledges by the standalone cache as if it were the native storage device. Similarly, the native storage device receives the I/O requests and fetches or stores the corresponding data. Caching logic in the standalone cache determines occupancy in the cache, and identifies when a request can be fulfilled by the cache rather than incurring an I/O to the storage device. No driver or other control need be resident on the host, due to independence of the standalone cache. Since the caching logic is inherent in the standalone cache, existing hosts may benefit from caching without host modification or storage volume upgrade.

### BACKGROUND

Caching a stream of I/O requests is often used in computer systems as a way of keeping recently changed data “close at hand” for further modifications. The concept of caching is based on the intuitive notion that something in a state of change is more likely to change again in the near future than an item that has been static for some time. A document being edited is likely to be periodically saved, hence the disk pages that store the document are more likely to be stored or recalled again before another document is retrieved.

Since accesses to a conventional hard disk drive (HDD) take substantially longer than accesses to conventional volatile memory such as DRAM or SDRAM (Dynamic Random Access Memory and Synchronous Dynamic Random Access Memory), a conventional caching mechanism simply maintains copies of recently active disk pages in main (volatile) memory so that subsequent activity to the same page need not incur a disk I/O. Other logic and safeguards are often incorporated to ensure that changes are not overwritten inadvertently and that there is only one “up to date” copy of the data, but generally caching enhances I/O performance by reducing disk I/O for frequently accessed items.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles of the invention.

FIG. 1 is a context diagram of a computing environment suitable for use with configurations herein;

FIG. 2 is a flowchart of standalone cache usage in the environment of FIG. 1;

FIG. 3 is a diagram of the standalone cache of FIG. 1 using a dynamic interface; and

FIG. 4 is a flowchart of cache logic in the standalone cache of FIG. 1.

### DETAILED DESCRIPTION

A standalone storage cache is responsive to a host independent of drivers or caching logic on the host. The standalone storage cache (standalone cache) interfaces between the host and corresponding storage device, and appears to each as the same I/O interface. I/O requests are sent by the host, and are received/acknowledged by the standalone cache as if it were the native storage device. Similarly, the native storage device receives the I/O requests and fetches or stores the corresponding data. Caching logic in the standalone cache determines occupancy in the cache, and identifies when a request can be fulfilled by the cache rather than incurring an I/O to the storage device. No driver or other control for the cache need be resident on the host, since the standalone cache appears to the host as if it were the main storage device. Since the caching logic is inherent in the standalone cache, existing hosts may benefit from caching without host modification to cache a hard disk drive (HDD) by using a non-volatile memory (NVM) or storage volume upgrade.

Configurations herein cache a primary storage medium of a host computing system, typically a hard disk drive (HDD), by invoking an NVM standalone cache inline between the host adapter and the HDD. Conventional approaches to caching employ several methods. A particular conventional approach uses a separate non-volatile memory (NVM) device, for example, a solid state disk (SSD), as a cache. The HDD is unaware of the cache, and it is still completely visible to and controlled by system software (e.g. the driver). The host implements caching at least in part by specialized system software, thus requiring specialized software on the host.

Another conventional approach is known as the “hybrid drive,” in which NVM and caching algorithms are components of the HDD itself. Host system software may operate unmodified and unaware that the drive contains an NVM cache. However, unlike the previous method, the user is unable to provide caching for any commodity hard drive independently of the cache. The HDD storage volume and corresponding cache are bound together.

Disclosed herein is a caching method that avoids drawbacks of both approaches. Unlike the former approach, the disclosed standalone cache is independent of system software, thus, it is operable for any unmodified BIOS, device driver, or operating system that accepts a commodity hard drive, thus it is independent of any proprietary caching algorithms or open source operating system in operation on the host.

Further, unlike the latter, hybrid drive approach, the cache is not bound to the host HDD. Thus, the user is free to select a brand, size, and cost of HDD independently of the cache, and the user is free to replace or upgrade the HDD inexpensively without replacing the cache.

In the standalone cache as disclosed, the OS (Operating System) and other software invoking the HDD need not be modified to use the cache. Caching algorithms are fully contained within the cache device, and system software does not need to issue commands to both the cache and the HDD. The user may install the cache onto an existing system without installing software. Particularly, no additional software is needed at boot time (e.g. an option ROM) or at run time (e.g. a filter driver) which would force the operating system to use the cache where it would normally communicate independently with the HDD. Furthermore, proprietary caching techniques are not exposed where they may be reverse engineered or forced to adopt the license of an open source operating system.

Configurations herein are based, in part, on the observation that computer users may want to enhance storage capacity by adding an additional off-the-shelf (commodity) drive for additional storage. Such commodity drives are readily available from various sources, and permit the user a range of capacity and pricing options before considering a larger system. Unfortunately, conventional approaches to the above approaches suffer from the shortcoming that caching functions are generally embedded in dedicated memory on the storage volume or integrated in the host as a portion of main memory, neither of which is readily adaptable to a commodity drive addition.

Accordingly, configurations herein substantially overcome the above described shortcoming of caching capability for add-on commodity drives by a standalone storage cache that requires no additional hardware or host drivers because it employs internal cache logic and is independent from, and not controlled by, the host. In contrast to the hybrid drives or host-based caches, the cache memory is responsive only to the onboard cache logic, and is not under the control of either the host or storage device. Conventional caching integrates the host I/O logic with the storage logic of the cached device. The caching parameters, such as a size of the caching area and the logic employed to estimate likely cache “hits” by determining which pages are likely to be recalled, are often an integral part of the host. In this manner, the standalone cache device provides a dynamic, independent cache that identifies a storage protocol of the native host and storage device, and emulates that protocol so the host requests are fulfilled transparently from either the cache or storage device as determined by the cache logic.

In a particular configuration, the standalone cache device is a non-volatile memory (NVM) cache disposed in-line between the host adapter and the storage volume (typically a hard drive, or HDD). Thus, software capable of using an HDD need not be modified to use the cache. Alternatively, a volatile memory or another magnetic medium may be used, but would of course have the power and impact vulnerabilities associated with such mediums.

The standalone storage cache includes a host interface for connection to a host computing device, and a storage volume interface comprising a protocol and a storage volume. A cache memory stores a recent history of stored items for subsequent access, and employs cache logic for receiving requests from the host interface and determining if the request can be satisfied using the cache memory. Therefore, the cache logic is independent from the host such that the host interface appears to the host as an interface to the storage volume, and caching algorithms are fully contained within the cache device. System software need not to issue commands to both the cache and the HDD, and the host interface does not receive caching instructions from the host, since the cache logic performs computations regarding cache entries and deletions. It follows that the host does not maintain a driver entry specific to the standalone storage cache, and the host interface is responsive to the same command set directed to the storage volume by the host.

The user may install the cache onto an existing system without installing additional software. In a particular configuration of the disclosed approach, no software is needed at boot time (e.g. an option ROM) or at run time (e.g. a filter driver) which would force the operating system to use the cache where it would normally communicate independently with the HDD. Furthermore, proprietary caching techniques are not exposed where they may be reverse engineered or forced to adopt the license of an open source operating system.

The description that follows depicts a standalone caching device and method to cache a hard disk drive (HDD) by using a standalone non-volatile memory (NVM) cache inline between the host adapter and the HDD provides seamless and non-intrusive caching support that avoids integration and driver control from a the host for providing improved I/O performance where the native host environment has insufficient caching.

The standalone caching device is connected between a host adapter and an HDD which provides a non-volatile cache for the HDD. Generally, the standalone caching device operates as a proxy of the HDD, hiding it from the host adapter, which responds to the host adapter as if it were the HDD. It may employ an existing form factor for dual port SAS (Serial-Attached SCSI) or SATA (Serial Advanced Technology Attachment) drives, where one port connects to the host adapter and the other to the HDD, such as a device which extends a USB (Universal Serial Bus) port to a USB external drive. The standalone device may also operate the HDD storage device independently of what power modes are requested by the host adapter. Additional features are discussed further below.

FIG. 1 is a context diagram of a computing environment 100 suitable for use with configurations herein. Referring to FIG. 1, in the computing environment 100, a host computing device, or host 110 includes a host system 112 having a processor 114 and memory 116, and a host interface 120 such as an input/output (I/O) adapter for communication with a storage device 130. The storage device 130 may be either a solid state drive 132, or a rotational hard drive (HDD) 134, or a combination typically referred to as a hybrid drive. The host I/O adapter 120 may be one of several adapters of the host system 112, which may also have a network adapter and a display adapter, for example, and is used for fulfilling I/O requests 140 to the storage device 130 for storing and retrieving data. The host I/O adapter (host adapter) 120 employs a protocol 122, such as SATA or IDE, for issuing the requests 140 to the storage device 130.

The storage device 130 has a storage volume interface 136 configured for communication with the host I/O adapter 120. However, in configurations herein, a standalone cache device 150 connects between the host I/O adapter 120 and the storage volume interface 136 for providing caching operations that facilitate satisfaction of the host requests 140. The standalone cache 150 includes cache logic 152 for directing caching operations and cache memory 154 for storing cached data. A cache interface 156 appears as a storage device 130 to the host I/O adapter 120, thus allowing unmodified issuance of the requests 140 from the host 110. Similarly, the cache interface 156 identifies a protocol 122 expected by the storage device 130, and appears to the storage devices 130 as the host I/O adapter 120, issuing commands in the protocol expected by the storage volume interface 136.

The cache memory 154, in a particular configuration is a NAND (Not AND) flash memory, although any suitable non-volatile memory may be employed, such as NOR (Not OR) flash memory, ferroelectric read-only memory (F-RAM, FeRAM, or FRAM), magnetoresistive read-only memory (MRAM) phase-change read-only memory (PRAM or PCM), electrically erasable programmable read only memory (EEPROM), to name several. Nonvolatile memory allows the drive to persist through disconnection and reconnection to the host, and verify host identity for security.

Since the standalone cache 150 emulates the native the storage device 130 of the host it servers, the standalone cache 150 is conversant in a storage protocol 122 employed by the host adapter 120. While some instructions (request 140) may simply be passed through, the cache logic 152 recognizes instructions for memory cell reclamation such as TRIM commands for solid state devices (SSD), which mark memory cells containing previously-used data as free to be erased. Since the TRIM commands do not apply to magnetic storage, the standalone cache device 150 is operable to receive TRIM commands from the host, determine if the TRIM commands apply to the cache or the storage volume; and refrain from passing through TRIM commands if inapplicable to the storage volume. The cache logic 152 may instead apply the effects of the TRIM command to cache memory 154, while software running on host system 112 continues to operate as if the TRIM command was actually applied to storage volume 130. Magnetic based drives need no TRIM commands, since magnetic media may be overwritten without first erasing; however in nonvolatile memory such as NAND memory, previously-written memory must be erased before new data can be written. Thus, in the example configuration, the TRIM commands are directed to non-volatile (NVM) memory for expunging previously written data.

Alternatively, SATA requests may incorporate a tag value, employed for mapping requests to completions in cases where multiple requests are outstanding simultaneously and may be completed in any order. The standalone cache 150 identifies and accommodates the protocol of the host adapter 120 and the storage device 130, such as SCSI, SAS, PATA (Parallel ATA, or IDE) SATA, USB, or Fibre Channel. Accordingly, the cache logic 152 is configured to recognize a tag on a request from the host system 112, in which the tag uniquely identifies a specific outstanding request; 140. The caching logic 152 may, in response to request 140, issue a request 142′ to storage volume interface 130. However, the set of tags used between host interface 122 and cache interface 156 may be independent of the tags used between cache interface 156 and storage volume interface 136. Thus, the tag accompanying request 140 may already be in use between cache interface 156 and storage volume interface 136. In this case, a modified tag must accompany request 142′ which is not currently used in any other outstanding request between cache interface 156 and storage volume interface 136. Thus, cache logic 152 must track a mapping between each original tag used between host adapter 122 and cache interface 156, and the corresponding modified tag used between cache interface 156 and storage volume interface 136. In the example, when storage volume interface issues a completion 142, cache interface 156 receives the completion with the accompanying modified tag. Cache logic 152 then retrieves the original tag via the mapping, and issues completion 142 with the accompanying original tag. The cache logic 152 discards the mapping after issuing the completion.

FIG. 2 is a flowchart of standalone cache usage in the environment of FIG. 1. Referring to FIGS. 1 and 2, at step 10, the method for caching data requests as disclosed herein includes disposing a standalone cache device 150 between a host adapter 120 and a corresponding storage device (volume) interface 136 responsive to the host adapter 120, in which the standalone cache 150 has cache logic 152 independent from the host adapter 120 and has cache memory 154 responsive to the cache logic 152 for storing the cached entries, typically memory pages. The standalone cache device 150 therefore receives no commands, only the data requests 140, from the host 112. All caching decisions are performed by the cache logic 152. The standalone cache device 150 receives a data request 140 from a host interface 112 on the host adapter 120, as depicted at step 11, and determines, via the cache logic 152, whether the data request 140 can be satisfied by the cache memory 154, as shown at step 12. The cache logic 152, being separate from the host system 112, need not rely on drivers or commands from the host 110, and the host 110 is not aware of the standalone storage device 150 because the requests 140 are the same as those that would be issued to the storage device 130 absent the standalone cache device 150.

The standalone cache device 150 communicates, based on the cache logic 152, the data request 140 to a storage volume interface 136, as depicted at step 13, and responds to the host 110 via the host interface 112 that the data request 140 has been fulfilled by a storage volume 130 coupled to the storage volume interface 136, such that the host is unaware of whether the data request was communicated to the cache memory 154 or the storage volume 130, as disclosed at step 14.

FIG. 3 is a diagram of the standalone cache of FIG. 1 using a dynamic interface. Referring to FIGS. 1 and 3, the standalone cache 150 enjoys portability and adaptability to various arrangements of host devices, typically personal computing devices such as tablets and notebooks. In FIG. 3, the standalone cache device 150 is disposed between an external dynamic interface on the host system 112 and an external dynamic interface on the storage volume 130, in which the external dynamic interfaces are configured for real-time connection, recognition and communication during uninterrupted host operation. A USB interface is particularly amenable to this arrangement, since USB connections are generally recognized dynamically, upon connection, and most devices are recognizable without additional driver or interface installations. Accordingly, FIG. 3 shows an example arrangement using a USB interface with an external storage device 130.

A USB cable 160 connects between the host adapter 120 and a host side 156′ of the cache interface 156. A second USB cable 162 connects between a storage device side 156″ of the cache interface 156. The USB cable 162 connects to the storage volume interface 136, which in this case is a USB compatible interface, typical of external storage devices. The storage device 130 may include any combination of rotating magnetic 134 and nonvolatile storage 132, such as NAND or other similar memory as discussed above. The plug-and-play nature of the USB connection also complements the standalone configuration of the cache device 150 as it does not require any drivers or control interface with the host system 112, since it appears to the host as the storage device 130 which it interfaces between.

System software will attempt to obtain information and configure the cache as if it were the HDD 134. Commands and command responses used to identify the drive may be relayed through the cache device 150, and the cache logic 152 may store information about the HDD in NVM. System software will request the geometry (i.e. the number and size of sectors) of the cache. The cache must query the HDD for its geometry (either by relaying the system's command or separately). The cache may report an equal or smaller size than the HDD (for example, reserving some HDD space for its own purposes). The cache may also report a different sector size (for example, if a different size is more convenient for caching).

System software may attempt to change power modes or instruct the cache to spin up or down as if it were the HDD. The cache may relay some of these commands to the HDD. It may manage other commands independently. For example, the cache may neglect to spin up a HDD if it can service requests from NVM. Host software may attempt to write to the cache as if it were the HDD. The cache may be a read cache, or it may be in write-through mode or write-back mode. As a read cache, cache logic would simply forward the write command to the HDD. The cache logic would relay the response from the HDD back to the host adapter.

FIG. 4 is a flowchart of cache logic in the standalone cache of FIG. 1. Referring to FIGS. 1 and 4, at step 200, the standalone cache 150 (cache) receives a request or command from the host adaptor 120 for a read or write request (typically for a page of memory). The cache logic 152 determines if is a read or write command, as depicted at step 202. In the case of a read, the cache logic 152 determines if the data is present in the cache memory 154, as shown at step 204. If so, the request is satisfied in a response 142 fetched 142′ from the cache memory 154, as depicted at step 206.

If there is no cache “hit” (requested page not found in the cache memory 154), then the request 140 is forwarded to the storage volume (HDD) 134, as shown at step 208, and receives a response (or completion) 142″ including the request page (step 210). The requested page 142″ is then written to the cache memory 154, at step 212, and forwarded to the host adapter 120 to satisfy the request 140, as depicted at step 214.

In the case of a write request 140, a check is performed at step 220 to determine if the cache has write capability. If not, then the cache logic 152 forwards the request 140 to the HDD, as depicted at step 222, receives the response fulfilling the page request at step 224, and forwards the response to the host adapter 120, as depicted at step 226, effectively passing through the request 140 as if the cache device 150 were not present.

If write capability is present, then a check is performed to identify if the cache is configured as write-through or write back, as shown at step 230. In the case of a write through cache, then at step 232 the cache logic writes the new data from the request 140 to the cache memory 154, and also forwards the command to the storage device 134 to effect the write, as depicted at step 234. The cache logic receives a response 142″ from the storage device 130 (step 236), and the cache logic 152 issues a response 142 to the host adapter 120 confirming that the request has been fulfilled, as depicted at step 238.

In the case of write-back operation, then at step 240 the cache logic 152 performs a check to determine if there is corresponding changed (“dirty”) data in the cache memory 154 corresponding to the page in the request 140. If the page was dirty, then the change data is written to the storage device, as shown at step 242, and the corresponding copy also stored in the cache memory, as shown at step 244. The response 142″ is received from the storage device 134, as depicted at step 246, and forwarded to the host controller 120 confirming the write. If the write was not dirty, then the response 140 data is simply written to the cache memory 154, as depicted at step 244, and a response 142 issued to the host adapter 120, as disclosed at step 248.

The standalone cache device 150 therefore operates as a proxy of the host adapter 120 from the point of view of the HDD 134. Thus, the drive needs no modification to enable caching. This allows existing HDDs 134 to be cached without modification. The user may upgrade or replace the HDD without compatibility concerns. Since the standalone cache device 150 proxies both the HDD and the host adapter, the user may add the cache to an existing system by simply unplugging the HDD from the host adapter, plugging the cache into the host adapter, and plugging the HDD into the cache device 150, as in the USB example above. In various embodiments, the cache may connect as a target device to a SAS, SATA, PATA, SCSI, or Fibre Channel host bus adapter (HBA), or USB host controller, or other type of host adapter. Likewise, the cache may connect as an initiator to an HDD via any of the same protocols. While it may not be a common use case, the protocols on either end of the cache need not match.

If the cache is a SAS or SATA initiator and target, it may utilize existing SAS/SATA HDD form factors. Thus, it may fit into a standard drive bay as if it were an HDD. It may also utilize existing dual port form factors. However, instead of both ports being targets, one port would be a target (connected to the host adapter), and the other would be an initiator (connected to the HDD). Note that the terms “initiator” and “target” differentiate between the side making a request (initiator) and the side that responds to a request (target). From the host point of view, the host is an initiator and the cache is a target. From the hard drive's point of view, the cache is an initiator and the hard drive is a target.

In the example arrangement, the cache memory is non-volatile memory (NVM), such as NAND, however other volatile or non-volatile memory could be used. The protocol 122 recognized by the cache logic 152 may be one of SCSI, SAS, PATA (IDE) SATA, USB, or Fibre Channel, to name several more common protocols, however any suitable protocol could be used.

Those skilled in the art should readily appreciate that the programs and methods defined herein are deliverable to a computer processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A standalone cache device comprising:
a host interface for connection to a host computing device;
a storage volume interface comprising a protocol and a storage volume;
a cache memory for storing a recent history of stored items for subsequent access; and
cache logic for receiving requests from the host interface and determining if the request can be satisfied using the cache memory,
the cache logic independent from the host such that the host interface appears to the host as an interface to the storage volume.

2. The device of claim 1 wherein:
the host interface does not receive caching instructions from the host; and
the cache logic performs computations regarding cache entries and deletions

3. The device of claim 2 wherein:
the host does not maintain a driver entry specific to the standalone storage cache; and
the host interface is responsive to the same command set directed to the storage volume by the host.

4. The device of claim 1 wherein the standalone storage cache is disposed between an external dynamic interface on the host and an external dynamic interface on the storage volume, the external dynamic interfaces configured for real-time connection, recognition and communication during uninterrupted host operation.

5. The device of claim 4 wherein the external dynamic interface is a USB (Universal Serial Bus) port.

6. The device of claim 1 wherein the standalone storage cache is operable to:
receive memory cell reclamation commands from the host;
determine if the memory cell reclamation commands apply to the cache or the storage volume; and
refrain from passing through memory cell reclamation commands if inapplicable to the storage volume.

7. The device of claim 6 wherein the memory cell reclamation commands are TRIM commands directed to non-volatile (NVM) memory for marking previously written data as no longer in use.

8. The device of claim 1 wherein the cache logic is configured to:
analyze receive read requests from the host;
determine a cache presence of a corresponding cached request;
identify a tag corresponding to the cache presence; and
implement, based on the cache presence and without direction from the host, a caching decision for satisfying the read request from the cache or from the storage volume.

9. The device of claim 1 wherein the cache logic is configured to:
recognize a first tag on a request from the host, the tag indicative of a unique outstanding request;
create a second tag associated with a second request to the storage volume;
associate the first tag with the second tag;
receive a first command response from the storage volume containing the second tag; and
render a second command response containing the first tag to the host.

10. The device of claim 1 wherein the cache logic is operable to:
indicate to the host a responsiveness to memory cell reclamation commands;
receive the memory cell reclamation commands from the host;
determine if the memory cell reclamation commands apply to the cache or the storage volume; and
refrain from passing through memory cell reclamation commands if inapplicable to the storage volume.

11. The device of claim 1 wherein the cache memory is one of at least NAND flash memory, NOR flash memory, ferroelectric RAM, magnetoresistive RAM, or phase change memory and the protocol is one of at least SCSI, SAS, PATA (IDE) SATA, USB, or Fibre Channel.

12. A method for caching data requests comprising:
disposing a standalone cache device between a host adapter and a corresponding storage device interface responsive to the host adapter, the standalone cache having cache logic independent from the host adapter and cache memory responsive to the cache logic;
receiving a data request from a host interface;
determining, via cache logic, whether the data request can be satisfied by a cache memory, the cache logic separate from a host coupled to the host interface;
communicating, based on the cache logic, the data request to a storage volume interface;
responding to the host via the host interface that the data request has been fulfilled by a storage volume coupled to the storage volume interface, such that the host is unaware of whether the data request was communicated to the cache memory or the storage volume.

13. The method of claim 12 further comprising determining if the request is a read request or write request and
determining, if a write request, if the cache is write through or write back;
writing, if the cache is write through, the request to the cache memory and the storage volume; and
if the cache is write back, determining if a corresponding invalid or clean entry is stored in the cache corresponding to the request, and storing the request in the cache if a clean entry is found and flushing the request to the storage volume if an invalid entry was found.

14. The method of claim 12 further comprising
performing computations regarding cache entries and deletions by the cache logic such that the host interface does not receive caching instructions from the host.

15. The method of claim 14 wherein:
the host does not maintain a driver entry specific to the standalone storage cache; and
the host interface is responsive to the same command set directed to the storage volume by the host.

16. The method of claim 12 further comprising
receiving memory cell reclamation commands from the host;
determining if the memory cell reclamation commands apply to the cache or the storage volume; and
refraining from passing through memory cell reclamation commands if inapplicable to the storage volume.

17. The method of claim 16 wherein the memory cell reclamation commands are TRIM commands directed to non-volatile (NVM) memory for marking previously written data as no longer in use.

18. The method of claim 14 further comprising
analyzing receive read requests from the host;
determining a cache presence of a corresponding cached request;
identifying a tag corresponding to the cache presence; and
implementing, based on the cache presence and without direction from the host, a caching decision for satisfying the read request from the cache or from the storage volume.

19. At least one non-transitory computer readable medium having instructions encoded thereon for performing a method of caching data requests, the instructions when executed on a computing device cause the computing device to perform a method comprising:
identifying, at a standalone cache, a host adapter and a corresponding storage volume interface responsive to the host adapter, the standalone cache having cache logic independent from the host adapter and cache memory responsive to the cache logic;
receiving a data request from a host interface on the host adapter;
determining, via cache logic, whether the data request can be satisfied by a cache memory, the cache logic separate from a host coupled to the host interface;
communicating, based on the cache logic, the data request to a storage volume interface;
responding to the host via the host interface that the data request has been fulfilled by a storage volume coupled to the storage volume interface, such that the host is unaware of whether the data request was communicated to the cache memory or the storage volume.

20. A computing appliance comprising:
a host interface for connection to a host computing device;
a storage volume interface comprising a protocol and a storage volume;
a cache memory for storing a recent history of stored items for subsequent access;
cache logic for receiving requests from the host interface and determining if the request can be satisfied using the cache memory,
the cache logic independent from the host such that the host interface appears to the host as an interface to the storage volume; and
a display attached to the host computing device for rendering data transferred in the requests.
